(19) United States
(12) Patent Application Publication
(10) Pub. No.: US 2013/0324156 A1
(43) Pub. Date: Dec. 5, 2013

(54) LOCATION SYSTEM FOR DETERMINING THE POSITION OF AN OBJECT

(71) Applicant: Carl Johan Erik Wallgren, Stockholm (SE)

(72) Inventor: Carl Johan Erik Wallgren, Stockholm (SE)

(73) Assignee: ATLAS COPCO INDUSTRIAL TECHNIQUE AB, Stockholm (SE)

(21) Appl. No.: 13/984,516

(22) PCT Filed: Jan. 26, 2012
(86) PCT No.: PCT/EP12/51236

§ 371 Date: Aug. 8, 2013

(30) Foreign Application Priority Data
Feb. 10, 2011 (SE) 1150105-3

(51) Int. Cl. G01S 5/10

(52) U.S. Cl. CPC G01S 5/10
USPC 455/456.1

(57) ABSTRACT

A location system for determining the position of a movable object (12) like a power wrench in a three dimensional space and comprising a number of stationary signal communication modules (15, 16 and 17) and a movable signal communication module (18) carried by the movable object (12), wherein the stationary signal communication modules (15, 16 and 17) are connected to an evaluation and calculation unit (24) which is arranged to determine the position of the movable object (12) in response to the signals delivered by the stationary signal communication modules (15, 16 and 17) and based on signals communicated between the movable signal communication module (18) and the stationary signal communication modules (15, 16 and 17). At least one (16) of the stationary signal communicating modules (15, 16 and 17) is displaceable between two or more positions (A,B) to enable signal communication contact with the movable signal communicating module (18) in normally screened off positions.

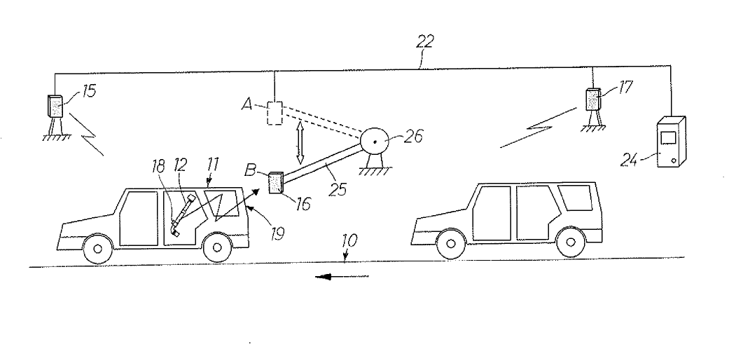

The invention relates to a location system for determining the actual position in a three dimensional space of a movable object by means of a number of stationary signal communicating modules located in the space, and a movable signal communicating module carried on the object for communication with the stationary signal communicating modules. In a preferred embodiment, the invention concerns a location system for determining the actual position of a power tool movable in a three dimensional space between two or more working positions on a working object.

A location system of the above mentioned type is suitable for determining the actual position of a power wrench or nut runner used in assembly applications on car bodies. This type of system is based on an exchange of signals between a signal communicating module on the power wrench and stationary signal communicating modules, i.e. a remote indication of the actual individual distances between the power wrench and each one of a number of stationary signal communicating modules which are disposed in well defined positions in the space surrounding the power wrench. The different distance related signals are communicated to an evaluation and calculating unit for determining the position of the object in the three dimensional space. The signal communicating modules may be of any suitable type, for instance optically, acoustically or radio frequency based, and signals from each one of the signal communicating modules corresponding to the individual distances between the power wrench and the stationary signal communicating modules are communicated to an evaluation or analysing unit wherein the actual three dimensional position of the power wrench is calculated. One such system of this type includes a signal transmitting tag mounted on the power wrench and arranged to respond to an activation signal and emit signals to the stationary signal communicating modules.

Systems of this type are used in car body assembly line stations to ascertain whether specific screw joints on the car body have been attended to at all and whether they have been tightened to specified desired tightening levels. This is not only a system for quality ensuring, but keeping track of the power wrench working positions relative to a specific car body and/or screw joint position on the car body and enabling checking of the power wrench operation data used on each screw joint as a way of guaranteeing safety of the end product, namely the motor car.

In U.S. Pat. No. 7,055,233 there is previously described an ultrasonic based location system for a power wrench used on car bodies travelling along an assembly line. This system is able to determine in which car body on the assembly line the power wrench is actually used, and whether the power wrench has been used on screw joints in specified positions on the car body. For instance, it is possible to ascertain whether each screw joint in specified positions on the car body has been tightened or not, and even whether the tightening result for each screw joint is approved or not. This known system is based on reflection from the power tool of ultrasonic waves emitted by stationary sensors located adjacent the assembly line.

However, a problem concerned with the above mentioned ultrasonic based system, and also with optical systems, resides in the difficulty to communicate with the power wrench in certain screw joint positions, for instance inside a car body, where parts of the car body screen off communication of sound or light signals. This means that there will be no or poor communication between the power wrench and the stationary signal communicating modules and, hence, no reliable distance responsive signal will be delivered to the evaluation unit. Even the operator himself may screen off the signals in some working positions. Also radio frequency signals may be seriously disturbed by car body parts or by the operator, resulting in poor and less reliable signals from the signal communicating modules to the evaluation unit.

It is an object of the invention to provide a location system including a number of stationary signal communicating modules and a movable signal communicating module carried on a movable object for determining the actual position of the movable object in a three dimensional space and adapted to obtain contact with the object also in difficult to reach positions within the space normally screened off by other objects or surrounding structures.

It is a further object of the invention to provide a location system for determining the actual position of a movable object in a three dimensional space by means of a number of stationary signal communicating modules located in the space and a movable signal communicating module carried on a movable object, wherein one or more of the stationary signal communicating modules are displaceable between two or more positions to obtain contact with the movable signal communicating module carried on a movable object also in difficult to reach positions normally screened off by surrounding structures or objects.

Further objects, features and advantages of the invention will appear from the following specification and claims.

A preferred embodiment of the invention is described below with reference to the accompanying drawing.

In the drawing there is shown a location system according to the invention applied on a three dimensional space at an assembly line 10 with a consecutive row of car bodies travelling along the line. In one of the car bodies 11 there is illustrated a power wrench 12 intended to be used inter alia for tightening screw joints inside the car body 11. A power wrench location system comprises three stationary signal communication modules 15, 16 and 17 located in well defined positions in the space, and one movable signal communication module 18 carried on the power wrench 12. The power wrench 12 is in fact a movable object the position of which is to be determined at certain points of time. The stationary signal communication modules 15, 16 and 17 are connected via wiring 22 to a stationary evaluation and calculating unit 24. The latter also contains means for supplying and receiving operation data from the power wrench 12 via a wireless communication. This wireless operation data communication between the power wrench 12 and the stationary unit 24 does not form a part of the invention and is, therefore, not described in further detail.

The stationary signal communication modules 15, 16 and 17 may be of the type sending out signals to be reflected by the signal communication module 18 attached to the power wrench 12. Alternatively, the movable signal communication module 18 on the power wrench 12 may be a signal communication tag or any other type of device sending out signals to be received by the stationary signal communication modules 15, 16 and 17. In either case the directions of the signals received by the stationary signal communication modules 15, 16 and 17 and the distances between each stationary signal communication module 15, 16 and 17 and the movable signal communication module 18 are indicated and evaluated by the evaluation and calculating unit 24. As a result of that signal evaluation the three dimensional position of the power wrench 12 in the space is determined.

Both the stationary signal communication modules 15, 16 and 17 and the movable signal communication module 18 are designed to emit and/or receive signals in response both to different distances and different directions between the modules. The signal communication module 18 on the power wrench 12 preferably also emits and/or reflects signals in response to its rotational positions of the power wrench 12 in different planes. For instance a signal communication module may be used which is able to indicate its rotational positions in as much as six dimensions of freedom, DOF. This type of the signal communication module is previously known per se and does not form any part of the invention.

Since the power wrench 12 is about to perform a tightening operation inside the car body 11 there are certain parts of the car body 11, the roof for instance, that would screen off the signals emitted by the stationary signal communication modules 15, 16 and 17 or the movable signal communication module 18 on the power wrench 12, which would result in a poor or broken signal communication between the stationary signal communication modules 15, 16 and 17 and the movable module 18 on the power wrench 12 and, hence, a loss of position indication of the power wrench. In order to solve this problem one of the stationary communication modules 16 is displaceable between two or more positions for getting a proper communication with the power wrench 12 inside the car body 11 via a window or door opening in the car body. In the example illustrated in the drawing FIGURE the signal communication module 16 is mounted on a pivoting arm 25 for movement between two well defined positions A and B. The pivoting arm 25 has a stationary pivot point 26. When the power wrench 12 is to tighten screw joints in certain positions inside the car body the signal communication module 16 is displaced from a position A to a position B via a swinging movement of the arm 25 to thereby get a free signal communication way relative to the movable signal communication module 18 on the power wrench 12 through a rear window opening 19 in the car body. The two positions A and B are well defined and their co-ordinates are stored in the evaluation and calculating unit 24.

In the illustrated example the signal communication module 16 is displaceable by means of a pivoting arm, but could as well be moveable otherwise, for instance along a rectilinear rail. The signal communication module 16 could be displaced between more than two specific positions. For instance, it could be successively movable along any certain path or freely in the space to find a favourable signal communication position. Although not described in further detail, the displaceable communication module 16 could be provided with a signal communication tag, and other stationary communication modules 15 and 17 could be adapted to continuously communicate with that signal communication tag, whereby the evaluation and calculating unit 24 could calculate both the momentary position of the signal communication module 16 and the momentary position of the power wrench 12.

In the described example the evaluation and calculating unit 24 is illustrated as a separate unit but may as well be incorporated in one of the stationary communication modules 15 and 17. It is also to be pointed out that the expression “signal communication modules” used throughout the application is meant to involve also mirrors used in some applications at the stationary module locations to reflect optical signals emitted by a light source on the object/power wrench.

Since the assembly line 10 and the car bodies are continuously moving, see illustrating arrow in the drawing, the system including the evaluation and calculation unit 24 has to be programmed to take that movement into account when determining the actual momentary position of the power wrench 12 in relation to the screw joints to be tightened. To that end each car body on the assembly line has been provided with an identification tag which tells the assembly plant system and the local station which type of car body, model etc. is passing through the assembly station and exactly where in the local space the car body is at a certain point of time. The model, etc. of the car body also tells the system exactly where the screw joints to be tightened are located on the car body which is a condition for an accurate and safe ascertainment of where the power wrench is in relation to the screw joints at a certain point of time. The evaluation and calculation unit 24 is programmed to evaluate and determine whether the power wrench 12 has performed an acceptable tightening operation on each of the screw joints by comparing the momentary location of the power wrench 12 with the location of the screw joint to be tightened and with the stored screw joint tightening data to be applied at that very screw joint.

1. Location system for determining within a three dimensional space the actual position of a movable object (12), comprising a number of stationary signal communicating modules (15, 16 and 17) located in well defined individual positions in the space, a movable signal communicating module (18) attached to the object (12), and an evaluation unit (24) communicating with the stationary signal communicating modules (15, 16 and 17) and arranged to calculate the actual position of the object (12) based on signals communicated between the stationary signal communicating modules (15, 16 and 17) and the movable signal communicating module (18) and corresponding to the individual distances between and/or angular positions of each one of the stationary signal communicating modules (15, 16 and 17) and the movable signal communicating module (18),
characterized in that at least one (16) of the stationary signal communicating modules (15, 16 and 17) is displaceable between two or more positions (A,B) to enable signal communication with the movable signal communicating module (18) on the object (12) in normally screened off positions.

2. Location system according to claim 1, wherein said two or more positions of said at least one (16) of the stationary signal communicating modules (15, 16 and 17) are well defined in relation to the positions of the other stationary signal communicating modules (15, 17).

3. Location system according to claim 1, wherein said at least one signal communicating module (16) is mounted on a pivot arm (25) for displacement between two well defined positions (A,B).

4. Location system according to claim 1, wherein the movable signal communicating module (18) is formed by a signal communication tag arranged to respond to an activation signal and to emit signals to reach the stationary signal communicating modules (15, 16 and 17).

5. Location system according to claim 1, wherein the stationary signal communicating modules (15, 16 and 17) and the movable signal communicating module (18) are arranged to respond to an actual multi-dimensional orientation of the object within the three dimensional space.
